(19) United States
(12) Patent Application Publication
(10) Pub. No.: US 2010/0296536 A1
(43) Pub. Date: Nov. 25, 2010

(54) LIGHTING DEVICE USING A LASER DIODE AS A SOURCE OF LIGHT EMISSION

(76) Inventor: CHRIS TAO, Kent, CT (US)

Correspondence Address: Maulin V. Shah, Esq., 1375 Broadway, Third Floor, New York, NY, 10018, US

(21) Appl. No.: 12/471,370

(22) Filed: May 23, 2009

(51) Int. Cl. H01S 3/04; H01S 3/00

(52) U.S. Cl. 372/36; 372/38.02; 372/109

(57) ABSTRACT

A laser diode lighting device for use in and powered through an incandescent, halogen, or fluorescent light bulb alternating current socket is provided. The lighting device includes a laser diode light, a regulation circuit and a base. The regulation circuit converts an alternating current input to a direct current output. The base is adapted to fit within a conventional light bulb alternating current socket. In addition to the laser diode light, regulation circuit and base, the invention can further include a heat sink that removes heat from the laser diode light, regulation circuit and combinations thereof The laser diode light, regulation circuit, base, and heat sink take the form of a lighting device that is exchangeable with conventional light bulbs in traditional lighting fixtures.

### BACKGROUND

1. Field of the Invention

This invention relates generally to lighting devices, and more particularly to a laser diode lighting device.

Description of Related Art

A laser diode is a laser where the active medium is a semiconductor. The most common and practical type of laser diode is formed from a p-n junction and powered by injected electric current. These devices are also sometimes referred to as injection laser diodes to distinguish them from optically pumped laser diodes, which are more easily produced in the laboratory. As with other diodes, an electrical current flows easily from the p-side, or anode, to the n-side, or cathode, but not in the reverse direction. Charge carriers (electrons and electron holes) flow into the junction from electrodes with different voltages. When an electron and an electron hole meet, the electron falls into a lower energy level, and releases energy in the form of a photon.

Laser diodes are not light-emitting diodes (LEDs), and laser diodes are distinguished from LEDs in many ways. LEDs are simply tiny light bulbs that can fit easily into an electrical circuit. But unlike ordinary incandescent bulbs, they do not have a filament that will burn out. They are illuminated solely by the movement of electrons in a semiconductor material. LEDs do not have a feedback cavity, which causes them to emit photons from recombining electrons in a very broad spectrum. Thus, LEDs produce incoherent light with a wide or high output pattern, just like an ordinary light bulb does.

On the other hand, in laser diodes, the active part of the depletion layer (i.e., where most of the current flows) is made quite narrow, thus concentrating the photon carriers. The ends of this narrow active region are also highly polished, or coated with multiple very thin reflective layers to act as mirrors, forming a resonant optical cavity, also known as a Q cavity. The result is that the laser emission line narrows drastically (more monochromatic) and the laser beam narrows somewhat spatially. Thus, laser diodes emit laser light in much smaller and more focused light patterns than LEDs.

Some commercially available high power laser diodes have overall conversion efficiency (electrical power-in to optical power-out) of over 50%. Current research in the field of laser diodes is attempting to boost the overall conversion efficiency past 80%. Incandescent, halogen, and fluorescent lamps, which are commonly used for a variety of lighting applications, each have an efficiency between 5%-20%. High brightness LEDs that may be suitable for lighting applications have a comparable efficiency of 10%-25%, still far below the efficiency of laser diodes. Furthermore, it is unlikely that LEDs can match the efficiency of laser diodes due to the structure and physical constraints of LEDs.

Therefore, there is a need for an apparatus that provides a high-efficiency lighting device which utilizes laser diodes as a source of light emission.

### SUMMARY

In one embodiment, the disclosure relates to a laser diode lighting device for use in a light bulb socket, comprising: a base adapted to fit within a light bulb socket; a circuit connected to the base, the circuit configured to receive an electrical current from the base; and at least one laser diode connected to the circuit, the laser diode configured to emit a laser light upon receiving the electrical current from the circuit.

In another embodiment, the disclosure relates to a laser diode lighting device, comprising: a base having two-prongs adapted to fit into a wall socket; a heat sink connected to the base, the heat sink configured to provide heat removal; a circuit connected to the heat sink, the circuit including a current rectifier and a voltage regulator for converting an alternating current input to a direct current output; and a laser diode connected to the circuit.

In still another embodiment, the disclosure relates to a laser light emitting device, comprising: a circuit board; an electrical wire connected to the circuit board and configured to be attached to an electrical source; and at least one array of laser diodes mounted on the circuit board and configured to emit laser light upon receiving an electric current from the electrical source.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 shows a perspective view of a laser diode lighting device;

FIG. 2 shows an exploded view of a laser diode lighting device;

FIG. 3 shows a cross-sectional view of a laser diode lighting device;

FIG. 4 shows a schematic diagram of regulation circuit for a laser diode lighting device;

FIG. 5 shows a screw base for a laser diode lighting device;

FIG. 6 shows a double-pin base for a laser diode lighting device;

FIG. 7 shows a face of a laser diode lighting device; and

FIG. 8 shows a laser diode lighting device with a plurality of laser diodes.

### DETAILED DESCRIPTION

The present invention comprises a simple to install, energy efficient laser diode lighting device that can be interchangeable with traditional incandescent, halogen, fluorescent, metal hydride, plasma, and LED light bulbs. As such, the present invention has utility as a lighting device anywhere that incandescent, halogen, fluorescent, metal hydride, plasma, and LED light bulbs are used.

The lighting device of the present invention is comprised of at least one laser diode, a regulation circuit and a base. In addition, it is preferable that the laser diode lighting device includes a heat sink. The base is adapted to fit within and attach to a traditional incandescent, halogen, fluorescent, metal hydride, plasma, or LED light bulb socket. The regulation circuit transforms the alternating current provided to the light bulb socket to a direct current usable by the laser diode. The heat sink removes heat from the laser diode and/or regulation circuit and preferably provides a body for the attachment of the other components of the lighting device.

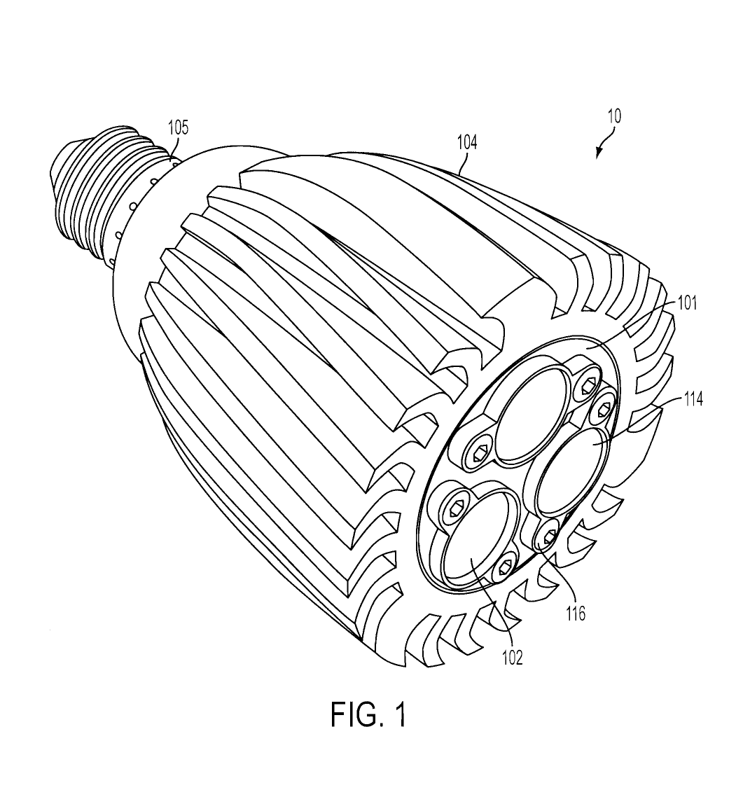

FIG. 1 shows a perspective view of a laser diode lighting device. The laser lighting device 10 of FIG. 1 a laser diode housing 101, at least one laser diode 102, a regulating circuit 103, a heat sink 104 and a base 105. In an embodiment, the laser diode housing 101 projects axially at the front side of the laser diode lighting device 10. In addition, the laser diode housing 101 provides support and secure positioning of the at least one laser diode 102. In an embodiment, the laser diode 102 is covered by a half-spherical lens 114 that is attached to the laser diode housing 101 by a screw 116. In another embodiment, a rivet, clip, hook, or any other attachment means can be used to securely attach the lens 114 to the laser diode housing 101.

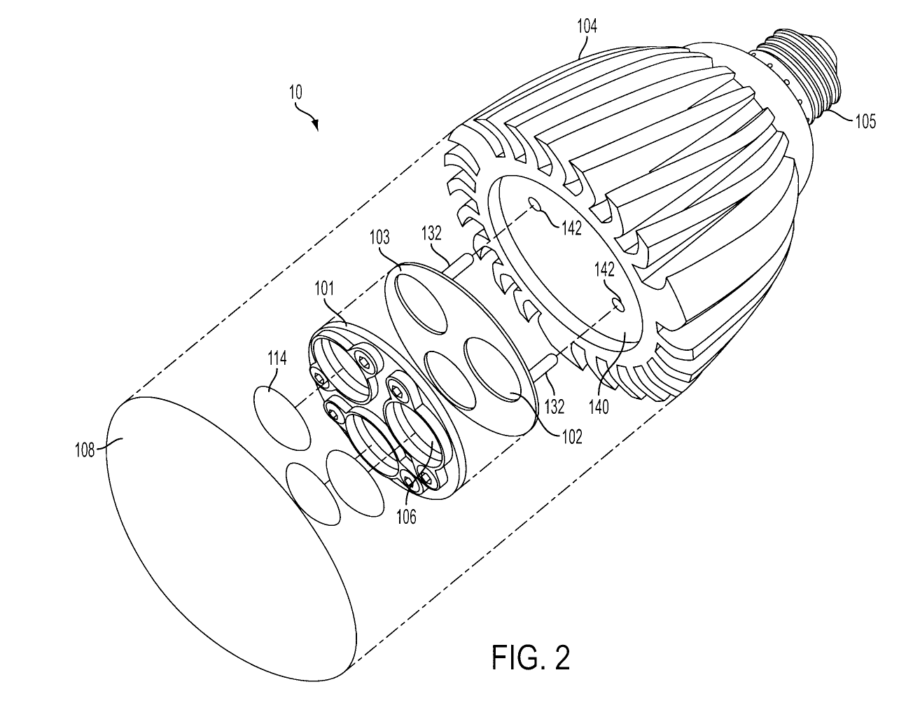

In an embodiment, the heat sink 104 is made of a ceramic or metal, preferably copper or aluminum. The fins of the heat sink 104 provide the heat sink 104 with a large surface area, which results in a high thermal conductivity and rapid transfer of thermal energy from the laser diodes 102 and regulation circuit 103 (shown in FIG. 2). In an embodiment, the regulation circuit 103 can be a printed circuit that is printed directly onto the heat sink 104. The heat sink 104 is not limited to the design shown in FIG. 1, and can be any design which allows for high thermal conductivity and rapid transfer of thermal energy from a heat generating source. In an embodiment, the heat sink 104 includes a fan or cooling device.

In an embodiment, the heat sink 104 possesses the appropriate dielectric properties such that the heat sink is an electrical insulator. The heat sink 104 affords for the laser diode housing 101, laser diode 102, regulating circuit 103 and/or base 105 to be attached thereto.

FIG. 2 shows an exploded view of a laser diode lighting device. The laser diode housing 101 receives the laser diode 102 through an opening 106 in the laser diode housing 101. The laser diode 102 projects axially forwardly through an opening 106 in the laser diode housing 101. In an embodiment, the laser diode housing 101 is covered with cover 108. The cover 108 can be a translucent cover spanning the diameter of the laser diode housing 101. The cover protects the surfaces of the lenses 114 and other internal components of the laser diode lighting device 10 components. In an embodiment, the cover 108 is made from a clear, transparent thermoplastic material, or alternatively, made from glass, and can encloses the laser diode 102 and the circuit 103.

The laser diode housing 101 can made from any material known to those skilled in the art, illustratively including polymers, metals, ceramics, glass and combinations thereof. In addition, the laser diode housing 101 can attach to the heat sink 104 using a variety of attachment means, illustratively including threads so as to screw onto the heat sink 104, a snap fit, clips and combinations thereof.

The laser diodes 102 can be any commercially available or non-commercially available laser diode, such as, but not limited to, double heterostructure lasers, quantum well lasers, quantum cascade lasers, separate confinement heterostructure lasers, distributed feedback lasers, vertical-cavity surface-emitting lasers (VCSELs), and/or vertical-external-cavity surface-emitting-laser.

In addition, the laser diode 102 can be any type of laser diode that is manufactured from aluminum gallium arsenide, aluminum gallium phosphide, aluminum gallium indium phosphide, gallium arsenide phosphide, gallium phosphide, gallium nitride, indium gallium nitride, silicon carbide, silicon, sapphire, zinc selenide, diamond, aluminum nitride, aluminum gallium nitride and combinations thereof.

Although three laser diodes 102 are shown in FIG. 1, different colors, combinations, and numbers of laser diodes may be used. In addition, each of the laser diodes 102 can be of a different color, i.e. each laser diode 102 can produce a different color light. In a preferred embodiment, three laser diodes are utilized, having a red-blue-green (RBG) color combination. One laser diode produces a red color, another laser diode produces a green color, and another laser diode produces a blue color, where a mixing of the intensities of all three laser diodes 102 produces a white color.

Other color combinations of laser diodes which do not produce a white color are also included in the present invention. For example, red-red-red or red-green-red laser diode combinations can be utilized to produce non-white colors. The laser diode lighting device 10 can utilize laser diodes 102 to generate laser light of any color/wavelength in the visible spectrum. In an embodiment, the laser diode lighting device 10 can include a switch or controller which allows a user to selectively activate or disengage specific laser diodes 102. For example, in the RBG laser diode combination, the red laser diode can be disengaged so that only the blue laser diode and the green laser diode emit laser light. In an embodiment, an array of laser diodes can be utilized to provide a higher intensity and luminescence emission from the laser diode lighting device 10.

In another embodiment, the laser diode lighting device 10 can include a combination of laser diodes and LED devices to create a hybrid laser lighting device. For example, the hybrid lighting device can include two laser diodes for every one LED device. In another embodiment, the hybrid lighting device can include one laser device for every two LED devices. The hybrid lighting device can include a switch or controller which allows a user to selectively activate or disengage only the laser diode(s), only the LED device(s), or a combination thereof.

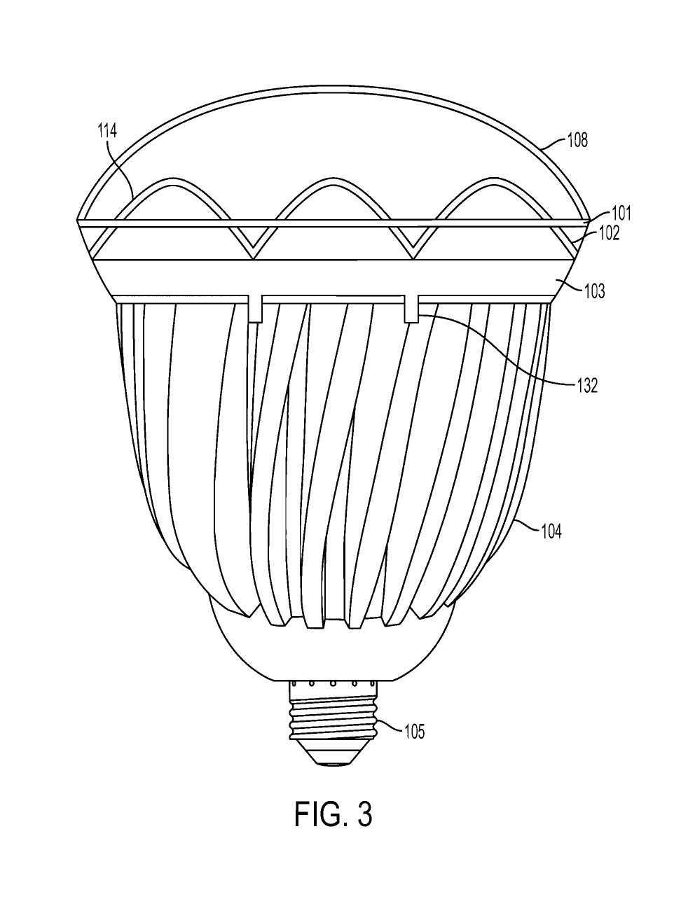

FIG. 3 shows a cross-sectional view of a laser diode lighting device. In an embodiment, each of the laser diodes 102 is covered by a half-spherical lens 114. The position of each of the laser diodes 102 with respect to its respective half-spherical lens 114 promotes a focused beam of laser light. The half-spherical lenses 114 act as collimating lenses, and focus emitting laser light into collimated beams of light with parallel emission paths. The focused beam of light facilitates illumination for great distances without scattering or broadening the light pattern. The half-spherical lenses 114 also helps to mix different colors of laser light, and helps to increase the radiation intensity of the laser light in the emission direction. The invention is not limited to the half-spherical lens design, and several styles of optics can be placed over the laser diode 102 to produce various color mixing effects and to defocus the laser beams to desired angles.

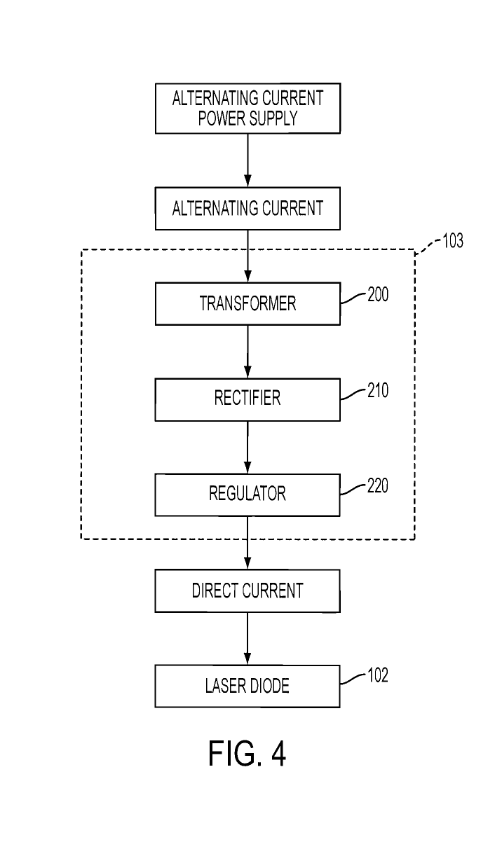

In an embodiment, the laser diode lighting device 102 includes a regulation circuit 103, which is preferably a printed circuit on a backing material. As shown in FIG. 4, the regulation circuit 103 affords for the transformation of an alternating current used to power a traditional incandescent light bulb to a direct current usable by the laser diode 102. For example, the regulation circuit 103 can transform a 110-120 volt alternating current used in North America and Japan to a 20 milliamp 2.2-2.6 volt direct current used by a red laser diode. Likewise, the regulating circuit 103 can transform a 110-120 volt or 220-240 volt alternating current to a 20 milliamp 3.5-4.0 volt direct current used by a green and/or blue laser diode.

The regulating circuit 103 can include any electronic device or component known to those skilled in the art to transform the alternating current input to the direct current output, illustratively including a transformer 200, a rectifier 210, and a regulator 220. Although not required for the present invention to be operable, the regulating circuit 103 can include a printed circuit on an appropriate backing, for example a circuit board. Referring to FIGS. 2 and 3, the circuit board can include a pin 132, said pin affording for the accurate placement of the circuit board onto the heat sink 104 by insertion into aperture 142, and/or electrical connection between the regulating circuit 103 and the base 105. In an alternative embodiment, the regulating circuit 103 can be a printed circuit printed directly onto the surface 140 of the heat sink 104.

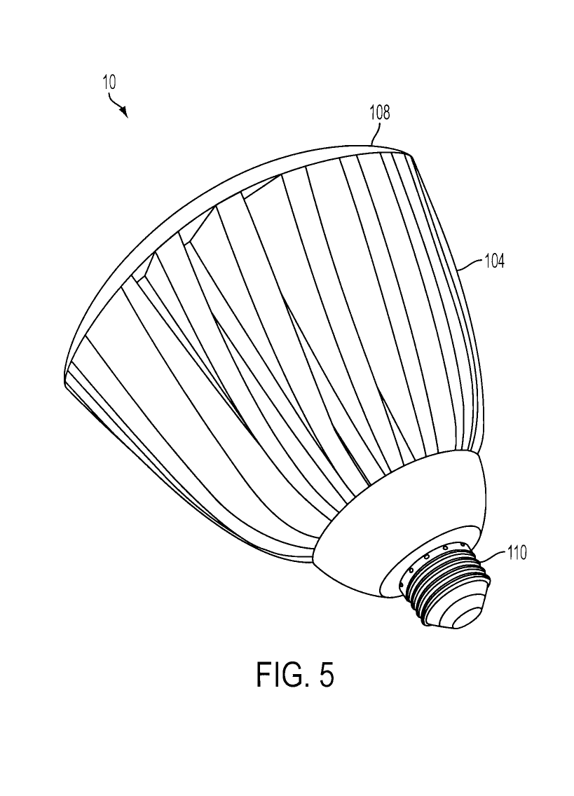

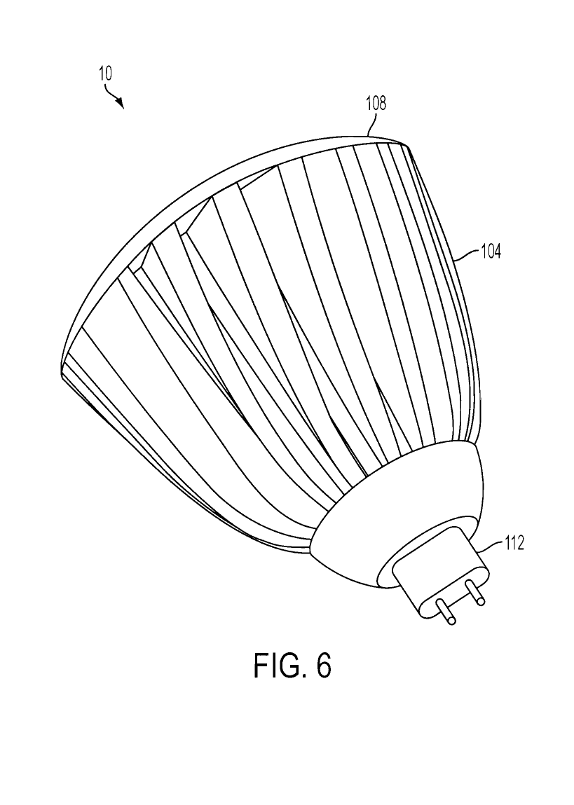

The base 105 as illustrated in FIGS. 1 and 2 can be a screw base that affords for the screwing of laser diode lighting device 10 into a threaded light bulb socket. As shown in FIG. 5, the screw base 105 can be adapted to fit within any threaded socket, illustratively including Edison screw 5 (E5), E10, E11, E12, E14, E17, E26, E27, E29, E39 and E40. Alternatively, the base can include a simple two-prong contact base 112 as shown in FIG. 6 that can be inserted into a conventional wall socket. In another embodiment, the base can include any number of prongs to fit a complimentary light socket, and is not limited to the designs shown in figures incorporated herein.

The invention also includes a laser diode lighting device 10 with interchangeable bases and replacement bases. The interchangeable bases allow for a particular laser diode 102 and regulating circuit 103 to be used with a plurality of traditional light sockets by simply replacing the base 105 with a suitable base. In addition, the interchangeable bases allows the laser diode lighting device 10 to be used in more than one size of light socket by simply removing a first base having one size and replacing the first base with a second base having a different size. In the alternative, the base 105 and the regulating circuit 103 can be interchangeable for the same purpose.

The base 105 is used to provide an electrical connection between, for example, an incandescent light bulb socket (not shown) and the regulating circuit 103. In an embodiment, the regulating circuit 103 is in electrical connection with the laser diode light 102. The electrical connection can be provided by a variety of connections means, illustratively including wires, electrodes, metal contacts, printed circuits and combinations thereof. Upon placement of the laser diode lighting device 10 of FIG. 1 within an incandescent light bulb socket, electrical power can be transmitted from the socket to the base 105, from the base 105 to the regulating circuit 103, and from the regulating circuit 103 to the laser diode 102.

As described above in greater detail, the regulating circuit 103 transforms the alternating current supplied to the incandescent light bulb socket to a direct current usable by the laser diode 102. After the transformation of the alternating current to the direct current, said direct current is supplied to the laser diode 102. Supplying the direct current to the laser diode 102 results in an electrical bias in the forward direction of the semiconductor chip laser diode 102. With the regulating circuit 103 ensuring the appropriate current and voltage to a given laser diode 102, electrons and electron holes flow into the p-n junction of the semiconductor material, wherein electrons that meet with electron holes fall into a lower energy level and release energy in the form of photons. In this manner, a laser diode lighting device 10 usable in any incandescent, halogen, fluorescent, metal hydride, plasma, or LED lighting fixture is provided.

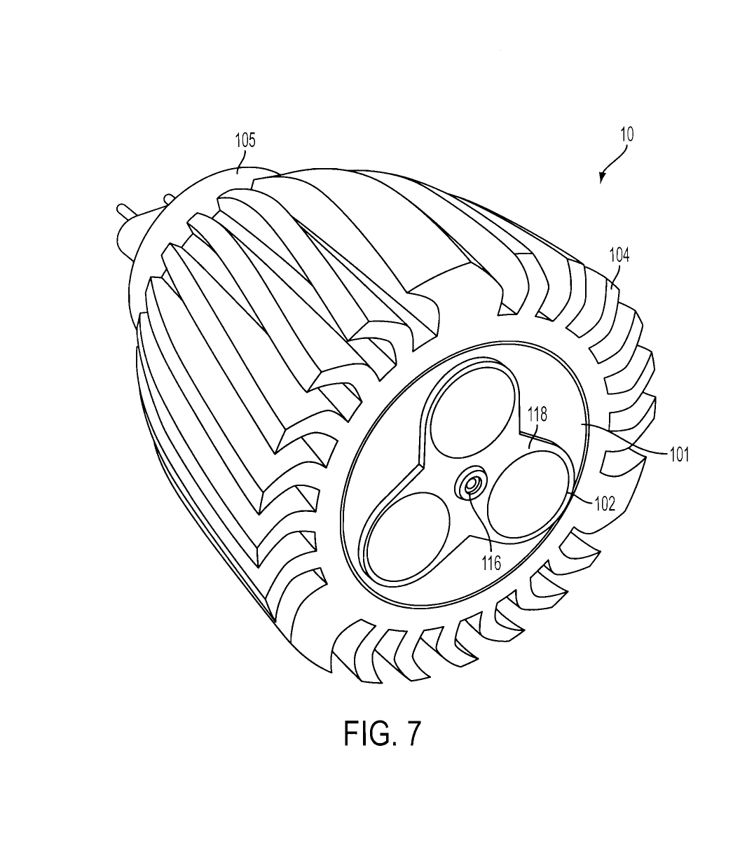

FIG. 7 shows a face of a laser diode lighting device. In an embodiment, the laser diode lighting device 10 can include multiple laser diodes 102. In a preferred embodiment, as described above, the laser diode lighting device 10 includes three laser diodes 102. The laser diodes 102 can be positioned in any configuration. As shown in FIG. 7, a single lens housing 118 can be attached to the laser diode housing 101 with screw 116. In an embodiment, the lens housing 118 is in substantially the same shape as the configuration of the laser diodes 102. In another embodiment, the lens housing 118 is molded with the laser diode housing 101, so that the lens housing 118 and the laser diode housing 101 are a single molded component.

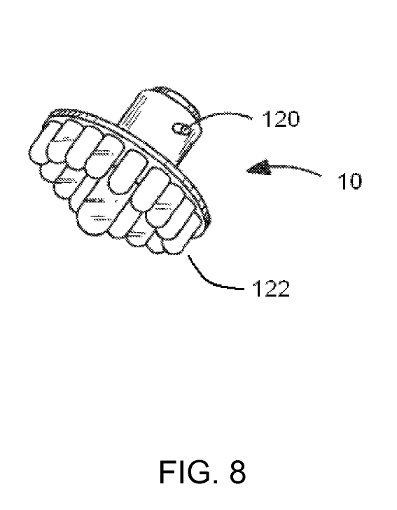

FIG. 8 shows a laser diode lighting device with a plurality of laser diodes. FIG. 8 shows an alternative embodiment of a laser diode lighting device 10 with a bayonet-type base 120 with two side prongs configured to connect with electrical contacts in a receptacle or socket. In another embodiment, a single prong can be used instead of two side prongs as shown. Further, the laser diode lighting device 10 includes a plurality of laser diodes 122. In an embodiment, plurality of laser diodes 122 may emit different colors, or can emit the same color.

In a preferred embodiment, the laser diodes 102 are arranged so that they emit laser light in optimal angles so that the laser light can be mixed and focused into a desired output color. In addition, the laser diode lighting device 10 can include as many laser diodes as can be accommodated on the surface area of the regulating circuit 103, or the surface area of the laser diode housing 101.

In another embodiment, the laser diode lighting device 10 does not include a base 105 or a bulb cover 108. Instead, the bulb-less laser diode lighting device can be housed in a downlight trim kit and adapted to fit into recessed housings for recessed wall or ceiling lighting. In this embodiment, the laser diode lighting device can include electrical connection wires instead of a base, and attachable to a recessed housing by a rotating clip or snap-fit retention system. The wires can be attachable to an electrical source.

In yet another embodiment, the laser diode lighting device 10 includes a flexible substrate that has surface mounted laser diodes arranged in an array configuration. The flexible substrate can be a flexible printed circuit board substrate, such as a flex circuit board or a rigid flex circuit board. The surface mounted laser diodes can be configured on the flexible substrate in an array comprising at least two sets of series-connected laser diodes, the series-connected sets coupled in parallel fashion to one another. In an embodiment, the arrays can be circular, rectangular, or have any type of geometric or free-form shape. The flexible printed circuit board substrate, in combination with the surface mount laser diodes, defines a conformable, bendable laser lighting array configured for mounting upon surfaces with a free-form curvature. In another embodiment, multiple laser diode arrays can be mounted on the circuit board, where each laser diode array emits a different color of laser light upon activation of the circuit by an electric current from the electrical source. In an embodiment, the electrical source can be a vehicle battery, traditional battery, fuel powered generator, or a renewable energy source such as solar, wind, hydro-electric.

In another embodiment, the laser diode lighting device 10 can include a multi-directional reflector to temper the brightness and intensity of the laser light being emitted. The reflector reflects the laser light in multi-directions and serves to provide a more uniform laser light intensity throughout the illuminated surface. The reflector also encloses the total laser light radiation to a pre-defined surface area.

Moreover, laser diode lighting device 10 can be used in a number of other applications, including but not limited to vacuum cleaner lights, flashlight, automotive lighting and other vehicular applications, accent lighting such as that used for under-cabinet lighting, wall art lighting, aquarium lighting and landscaping or architectural lighting. Other applications also can include, but not limited to, outdoor sports venue lighting, medical applications and the like.

While the principles of the disclosure have been illustrated in relation to the exemplary embodiments shown herein, the principles of the disclosure are not limited thereto and include any modification, variation or permutation thereof.

What is claimed is:

1. A laser diode lighting device for use in a light bulb socket, comprising:
a base adapted to fit within a light bulb socket;
a circuit connected to the base, the circuit configured to receive an electrical current from the base; and
at least one laser diode connected to the circuit, the laser diode configured to emit a laser light upon receiving the electrical current from the circuit.

2. The laser diode lighting device of claim 1, wherein the base is adapted to fit into an incandescent, halogen, or fluorescent light bulb socket.

3. The laser diode lighting device of claim 1, wherein the circuit is further configured to convert an alternating current into a direct current.

4. The laser diode lighting device of claim 1, wherein three laser diodes are connected to the circuit.

5. The laser diode lighting device of claim 4, wherein the three laser diodes have a red-blue-green color combination.

6. The laser diode lighting device of claim 1, wherein the base is selected from a group consisting of a screw base, bayonet base, or a two-prong contact base.

7. The laser diode lighting device of claim 1, wherein the base is interchangeable with a replacement base.

8. A laser diode lighting device, comprising:
a base having two-prongs adapted to fit into a wall socket;
a heat sink connected to the base, the heat sink configured to provide heat removal;
a circuit connected to the heat sink, the circuit including a current rectifier and a voltage regulator for converting an alternating current input to a direct current output; and
a laser diode connected to the circuit.

9. The laser diode lighting device of claim 8, wherein the heat sink includes a fan.

10. The laser diode lighting device of claim 8, further comprising a lens positioned in front of the laser diode.

11. The laser diode lighting device of claim 10, wherein the lens is a collimating lens.

12. The laser diode lighting device of claim 8, wherein the heat sink is configured to conduct an electric current from the base to the circuit.

13. The laser diode lighting device of claim 8, further comprising a transparent cover enclosing the circuit and the laser diode.

14. The laser diode lighting device of claim 8, further comprising a reflector positioned in front of the laser diode.

15. A laser light emitting device, comprising:
a circuit board;
an electrical wire connected to the circuit board and configured to be attached to an electrical source; and
at least one array of laser diodes mounted on the circuit board and configured to emit laser light upon receiving an electric current from the electrical source.

16. The laser light emitting device of claim 15, wherein the circuit board is flexible.

17. The laser light emitting device of claim 15, wherein the array of laser diodes includes at least two sets of series-connected laser diodes connected in parallel with one another.

18. The laser light emitting device of claim 15, wherein the electrical source is a vehicle battery.

19. The laser light emitting device of claim 15, wherein the circuit board is a printed circuit that is printed onto a heat sink.

20. The laser light emitting device of claim 15, further comprising a plurality of laser diode arrays, each laser diode array configured to emit a different color of laser light.
